(19) United States
(12) Patent Application Publication
(10) Pub. No.: US 2015/0257115 A1
(43) Pub. Date: Sep. 10, 2015

(54) APPARATUS AND METHOD

(71) Applicant: RENESAS MOBILE CORPORATION, Chiyoda-ku, Tokyo (JP)

(72) Inventors: Matti Kullervo Jokimies, Salo (FI); Hannu Petri Hietalahti, Kiviniemi (FI); Marko Tapani Niemi, Oulu (FI)

(73) Assignee: RENESAS MOBILE CORPORATION, Chiyoda-ku, Tokyo (JP)

(21) Appl. No.: 14/433,238

(22) PCT Filed: Oct. 1, 2013
(86) PCT No.: PCT/IB2013/059038

§ 371 Date: Apr. 2, 2015

(30) Foreign Application Priority Data
Oct. 2, 2012 (GB) 1217618.6

(51) Int. Cl. H04W 60/04

(52) U.S. Cl. CPC H04W 60/04

(57) ABSTRACT

An apparatus and method in which a User Equipment (UE) can register with a wireless network without requiring a packet data connection to be established. Embodiments are described in which a UE can indicate to a Mobility Management Entity that a packet data connection is not required to be established immediately. This can free resources when the UE knows that it will not need to transmit or receive data for some time, which is often the case for UE using Machine to Machine communication. In other embodiments, the MME can delay the establishment of a data connection for a UE if there are temporarily not enough resources to support it. In one embodiment, an apparatus for configuring a user equipment for transmission of data over a wireless network is provided. The apparatus comprises a processor arranged to, when in an unregistered state: transmit a message comprising first data indicating a request for attachment to the network, wherein the first data includes an indication that the user equipment supports registration without establishing a packet data connection; and responsive to receipt of a message comprising second data indicating an acceptance of the request for attachment to the network, selectively configure the user equipment to one of a registered state without a packet data connection and a registered state with a packet data connection in dependence on the second data.

### TECHNICAL FIELD

The present invention relates to an apparatus and method in which the registration of a user equipment with a wireless network can be separated from the establishment of a packet data connection for the user equipment.

### BACKGROUND

In the 3GPP LTE system packet data connectivity is provided by the Evolved Packet System (EPS) which consists of the Evolved Packet Core Network (EPC) and Evolved Universal Terrestrial Radio Access Network (E-UTRAN). The protocol for attaching a device to the EPS is given in the 3GPP Technical Specification 24.301 V11.3.0 (June 2012), incorporated herein by reference. This protocol specifies how during the EPS attach procedure a default EPS bearer context is activated. The default EPS bearer context gives a packet data connection which provides a subscriber with ready-to-use IP connectivity and an always-on experience.

It would be desirable in some circumstances to separate the attachment of a device to the EPS from the activation of any EPS bearer context, including the default EPS bearer context. For example, devices using Machine Type Communication (MTC) for Machine-to-Machine (M2M) communications may know that they will not require a data connection for a long period of time. Such devices would still wish to register their presence with the network, but the allocation of a default EPS bearer context is not required on attachment and can represent inefficient use of network resources.

The procedures defined in 3GPP Technical Specification 24.301 V11.3.0 do not allow the network much flexibility to delay the activation of the default EPS bearer context at times of network congestion, when there are insufficient network resources to meet the request.

### SUMMARY

According to a first embodiment, there is provided an apparatus for configuring a user equipment for transmission of data over a wireless network. The apparatus comprise a processor arranged to, when in an unregistered state, transmit a message comprising first data indicating a request for attachment to the network, wherein the first data includes an indication that the user equipment supports registration without establishing a packet data connection. Responsive to receipt of a message comprising second data indicating an acceptance of the request for attachment to the network, the user equipment is selectively configured to one of a registered state without a packet data connection and a registered state with a packet data connection in dependence on the second data.

According to another embodiment, there is provided an apparatus for registering and for establishing packet data connections for user equipment on a wireless network. The apparatus comprises a processor arranged to, in response to receipt of a message comprising first data indicating a request for attachment to the wireless network from the user equipment:

register the user equipment on the wireless network;

either establish or not establish a packet data connection for the user equipment in dependence on the first data; and

transmit a message comprising second data indicating an acceptance of the request for attachment to the network and whether a packet data connection has been established for the user equipment.

According to a further embodiment, there is provided a method of configuring a user equipment for transmission of data over a wireless network. The method comprising:

transmitting, by the user equipment, a message comprising first data indicating a request for attachment to the network, wherein the request includes an indication that the user equipment supports registration without establishing a packet data connection; and

responsive to receipt, by the user equipment, of a message comprising second data indicating an acceptance of the request for attachment to the network, selectively configuring the user equipment to one of a registered state without a packet data connection and a registered state with a packet data connection in dependence on the second data.

According to another embodiment, there is provided a method of registering and establishing packet data connections for user equipment on a wireless network. The method comprises, in response to receipt from a user equipment of a message comprising first data indicating a request for attachment to the wireless network from the user equipment:

registering, by the wireless network, the user equipment on the wireless network;

either establishing or not establishing a packet data connection for the user equipment in dependence on the first data; and

transmitting, by the wireless network, a message comprising second data indicating an acceptance of the request for attachment to the network and further comprising an indication of whether a packet data connection has been established.

According to a yet further embodiment, there is provided an apparatus for configuring user equipment for transmission of data over a wireless network. The apparatus comprises a processor arranged to, when in an unregistered state:

receive broadcast system information from the network; and

transmit a message comprising first data indicating a request for attachment to the network, wherein the first data includes an indication that the user equipment supports registration without establishing a packet data connection in dependence on the broadcast system information.

According to still another embodiment, there is provided an apparatus for registering and for establishing packet data connections for user equipment on a wireless network. The apparatus comprises a processor arranged to broadcast system information including an indication that the network supports registration without establishing a packet data connection; and, responsive to receipt of a message comprising first data indicating a request for attachment to the wireless network from the user equipment:

register the user equipment on the wireless network; and

either establish or not establish a packet data connection for the user equipment in dependence on the first data.

Further features and advantages of the invention will become apparent from the following description of preferred embodiments of the invention, given by way of example only, which is made with reference to the accompanying drawings.

### BRIEF DESCRIPTION OF THE DRAWINGS

FIG. 1 is a simplified block diagram of a communication network within which embodiments operate;

FIG. 2 is a simplified block diagram of various network devices, which are exemplary electronic devices suitable for use in practicing the exemplary embodiments;

FIG. 3 is a diagrammatic representation of signal flows between a UE and an MME in one embodiment;

FIG. 4 depicts a flow chart of the processing carried out by the UE in the embodiment of FIG. 3;

FIG. 5 depicts a flow chart of the processing carried out by the MME in the embodiment of FIG. 3;

FIG. 6 is a diagrammatic representation of signal flows between a UE and an MME in another embodiment;

FIG. 7 depicts a flow chart of the processing carried out by the UE in the embodiment of FIG. 6;

FIG. 8 depicts a flow chart of the processing carried out by the MME in the embodiment of FIG. 6; and

FIG. 9 is a diagrammatic representation of additional signal flows between a UE and an MME in a further embodiment.

### DETAILED DESCRIPTION

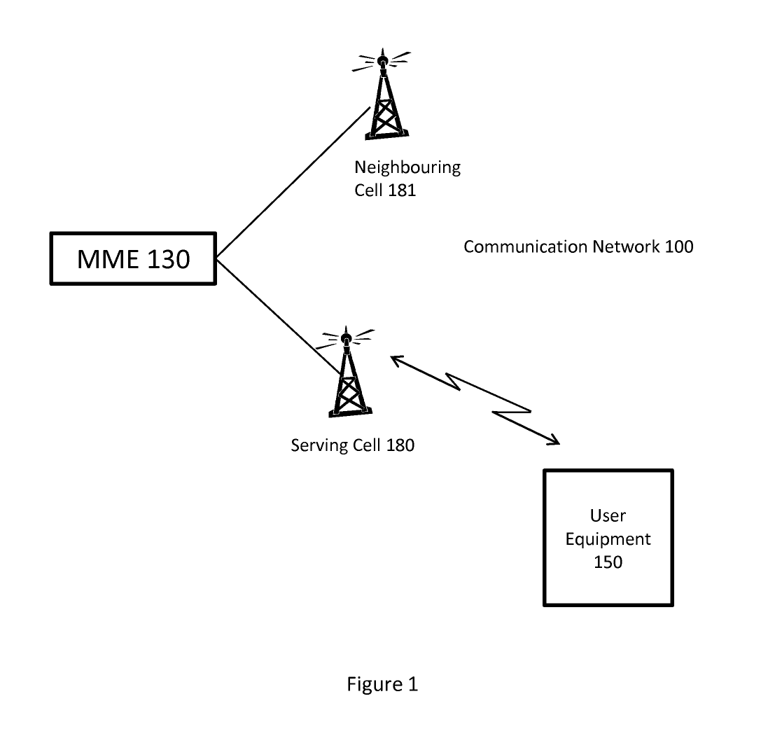

A basic system architecture of a communication network where examples of embodiments are practised may comprise a commonly known architecture of one or more communication networks comprising a wired or wireless access network subsystem and a core network. An exemplary communication network will now be described with reference to FIG. 1. FIG. 1 depicts a diagrammatic representation of a LTE (Long Term Evolution) network which makes use of a so-called evolved Node B (eNB) 6 where the RF transceiver and resource management/control functions are combined into a single entity. The communication network 100 may comprise a serving cell 180 that is currently serving a user equipment (UE) 150, a neighbouring cell 181 that is a neighbour of the serving cell 180 and a Mobility Management Entity (MME) 130. Although the MME is depicted as a separate entity, in communication with the serving cell 180 and the neighbouring cell 181, it can also be integrated in the serving cell 180 and the neighbouring cell 181. The serving cell 180 and the neighbouring cell 181 each comprise an eNB for serving user equipments within their radio coverage area. The user equipment 150 or another wireless transmit/receive device having a similar function, such as a modem chipset, a chip, a module etc., which can also be part of a user equipment or attached as a separate element to a user equipment, or the like, is able to communicate with the serving cell 180 or the neighbouring cell 181 via one or more channels for transmitting several types of data.

The communication network 100 may additionally be in communication with various further mobility management entities (not shown), which facilitate mobility of user equipments across various carriers and is responsible for a data bearer activation/deactivation process, and/or network management entities, which manage resources of the communication network 100.

The general functions and interconnections of the described elements, which also depend on the actual network type, are known to those skilled in the art and described in corresponding specifications, so that a detailed description thereof is omitted herein. However, it is to be noted that several additional network elements and signalling links may be employed for a communication connection to or from user equipments, cells or MMEs, besides those described in detail herein below.

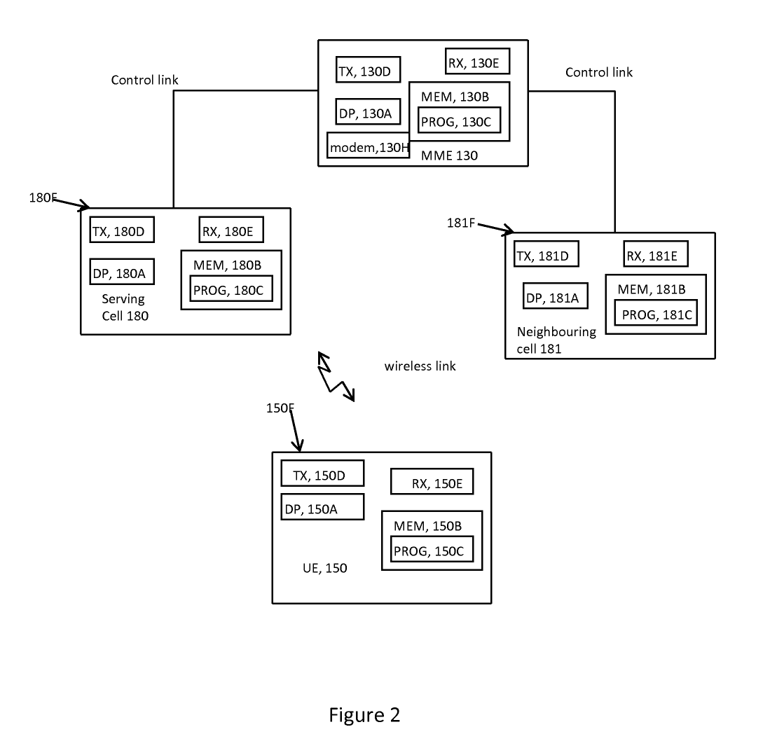

Reference is now made to FIG. 2 for illustrating a simplified block diagram of various electronic devices and apparatus that are suitable for use in practicing the exemplary embodiments of this invention. In FIG. 2 a serving cell 180 or a neighbouring cell 181 is adapted for communication over a wireless link with a user equipment 150, such as a mobile terminal. The serving cell 180 or the neighbouring cell 181 is an eNB in this embodiment be may also be a macro Node B, a remote radio head, relay station, a femto cell or home NodeB, or other type of base station/cellular network access node.

The user equipment 150 may include processing means such as at least one data processor (DP) 150A, storing means such as at least one computer-readable memory (MEM) 150B storing at least one computer program (PROG) 150C, and also communicating means such as a transmitter TX 150D and a receiver RX 150E for bidirectional wireless communications with the serving cell 180 and/or the neighbouring cell 181 via one or more antennas 150F.

The serving cell 180 includes its own processing means such as at least one data processor (DP) 180A, storing means such as at least one computer-readable memory (MEM) 180B storing at least one computer program (PROG) 180C, and communicating means such as a transmitter TX 180D and a receiver RX 180E for bidirectional wireless communications with other devices under its control via one or more antennas 180F. There is a data and/or control path, termed at FIG. 2 as a control link which in the 3GPP LTE cellular system may be implemented as an S1 interface, coupling the serving cell 180 with the MME 130, and over which the MME 130 and the serving cell 180 may exchange control messages, such as change notifications. The serving cell 180 also has stored in its local memory at 180B the database which may comprise data indicative of system information transmitted on a BCCH corresponding thereto, as the case may be for the various embodiments detailed above.

Similarly, the neighbouring cell 181 includes its own processing means such as at least one data processor (DP) 181A, storing means such as at least one computer-readable memory (MEM) 181B storing at least one computer program (PROG) 181C, and communicating means such as a transmitter TX 181D and a receiver RX 181E for bidirectional wireless communications with other devices under its control via one or more antennas 181F. There is a data and/or control path, termed at FIG. 2 as a control link which in the 3GPP LTE cellular system may be implemented as an S1 interface, coupling the neighbouring cell 181 with the MME 130, and over which the MME 130 and the neighbouring cell 181 may exchange control messages, such as system information update requests and/or change notifications. The neighbouring cell 181 also has stored in its local memory at 181B the database which may comprise data indicative of system information transmitted on a BCCH corresponding thereto, as the case may be for the various embodiments detailed above.

The MME 130 includes processing means such as at least one data processor (DP) 130A, storing means such as at least one computer-readable memory (MEM) 30B storing at least one computer program (PROG) 130C, and communicating means such as a modem 130H for bidirectional communication with the eNB 180 over the control link.

While not particularly illustrated for the user equipment 150, the serving cell 180, the neighbouring cell 181 and the MME 130, those devices are also assumed to include as part of their wireless communicating means a modem which may be inbuilt on a radiofrequency RF front end chip within those devices 150, 180, 181, 130 and which chip also carries the TX 150D/180D/181D/130D and the RX 150E/180E/181E/130E.

Various embodiments of the user equipment 150 can include, but are not limited to: cellular telephones; data cards, USB dongles, laptop computers, personal portable digital devices having wireless communication capabilities including but not limited to laptop/palmtop/tablet computers, digital cameras and music devices, Internet appliances and machine-to-machine communication devices such as telematics, security, automatic meter reading, payment and vending machines.

At least one of the PROGs 150C in the user equipment 150 is assumed to include program instructions that, when executed by the associated DP 150A, enable the device to operate in accordance with the exemplary embodiments of this invention, as detailed above. The serving cell 180, the neighbouring cell 181 and the MME 130 also have software stored in their respective MEMs to implement certain aspects of these teachings. In these regards the exemplary embodiments of this invention may be implemented at least in part by computer software stored on the MEM 150B, 180B, 181B, 130B which is executable by the DP 150A of the user equipment 150, DP 180A of the serving cell 180, DP 181A of the neighbouring cell 181 and/or DP 130A of the MME 130, or by hardware, or by a combination of tangibly stored software and hardware (and tangibly stored firmware). Electronic devices implementing these aspects of the invention need not be the entire devices as depicted at FIG. 2, but exemplary embodiments may be implemented by one or more components of same such as the above described tangibly stored software, hardware, firmware and DP, or a system on a chip SOC, an application specific integrated circuit ASIC or a digital signal processor DSP.

Various embodiments of the computer readable MEMs 150B, 180B, 181B and 130B include any data storage technology type which is suitable to the local technical environment, including but not limited to semiconductor based memory devices, magnetic memory devices and systems, optical memory devices and systems, fixed memory, removable memory, disc memory, flash memory, DRAM, SRAM, EEPROM and the like. Various embodiments of the DPs 150A, 130A, 181A and 180A include but are not limited to general purpose computers, special purpose computers, microprocessors, digital signal processors (DSPs) and multi-core processors.

Although at least some aspects of the embodiments described herein with reference to the drawings comprise computer processes performed in processing systems or processors, the invention also extends to computer programs, particularly computer programs on or in a carrier, adapted for putting the invention into practice. The program may be in the form of non-transitory source code, object code, a code intermediate source and object code such as in partially compiled form, or in any other non-transitory form suitable for use in the implementation of processes according to the invention. The carrier may be any entity or device capable of carrying the program. For example, the carrier may comprise a storage medium, such as a solid-state drive (SSD) or other semiconductor-based RAM; a ROM, for example a CD ROM or a semiconductor ROM; a magnetic recording medium, for example a floppy disk or hard disk; optical memory devices in general; etc.

It will be understood that the processor or processing system or circuitry referred to herein may in practice be provided by a single chip or integrated circuit or plural chips or integrated circuits, optionally provided as a chipset, an application-specific integrated circuit (ASIC), field-programmable gate array (FPGA), digital signal processor (DSP), etc. The chip or chips may comprise circuitry (as well as possibly firmware) for embodying at least one or more of a data processor or processors, a digital signal processor or processors, baseband circuitry and radio frequency circuitry, which are configurable so as to operate in accordance with the exemplary embodiments. In this regard, the exemplary embodiments may be implemented at least in part by computer software stored in (non-transitory) memory and executable by the processor, or by hardware, or by a combination of tangibly stored software and hardware (and tangibly stored firmware).

In a wireless network providing packet data connectivity to user equipment according to the 3GPP LTE protocols, packet data connectivity is provided by the Evolved Packet System (EPS) which consists of the Evolved Packet Core Network (EPC) and Evolved Universal Terrestrial Radio Access Network (E-UTRAN). 3GPP Technical Specification 23.401 V11.2.0 (June 2012), incorporated herein by reference, specifies the procedures for initial attachment to E-UTRAN. More information on the protocol for attaching a device to the EPS is given in the 3GPP Technical Specification 24.301 V11.3.0 (June 2012), incorporated herein by reference. 3GPP TS 24.301 specifies how during the EPS attach procedure a default EPS bearer context is activated, using different terminology from 3GPP TS 23.401. 3GPP TS 24.301 specifies the communications between a user equipment (UE) and a Mobility Management Entity (MME), section 5.5.1.2 describes the “Attach procedure for EPS Services”. The embodiments described below allow attachment to a packet data system without the activation of a default packet data system bearer context. The following embodiments will be described with reference to 3GPP TS 24.301 and the terminology used herein is that of 3GPP TS 24.301 unless otherwise noted.

Attachment to a wireless network is initiated by the UE. The UE can therefore indicate to the MME that it supports registration which is separate from the activation of a default packet data system bearer context. The indication is made by the UE in the request for attachment. In some embodiments the indication is implicit, for example by omitting a packet data connectivity request from an attach request according to 3GPP TS 24.301 V11.3.0. In other embodiments, the indication is explicit, for example by adding a new information element to the attach request or by using dedicated control messages for attachment without establishment of a default bearer context. Embodiments will be described below in which the UE either has prior knowledge or has no prior knowledge of whether the MME supports attachment without establishment of a packet data connection.

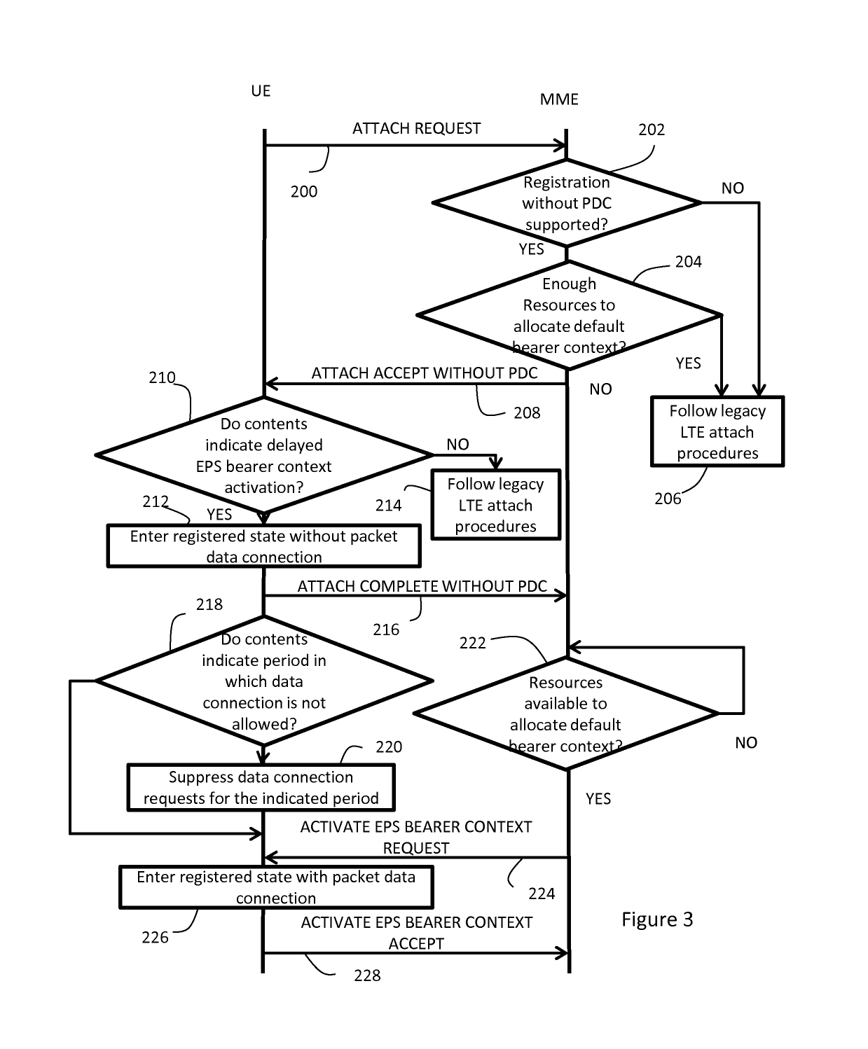

FIG. 3 is a diagrammatic representation of signal flows between a UE and MME to register the UE with the network in one embodiment. In this embodiment the UE does not have prior knowledge whether the MME supports registration which is separate from establish of a default packet data connection. This embodiment will be described in the context of attaching to an EPS according to 3GPP LTE protocols, but it will be appreciated that the embodiment can be applied to any other system in which separate registration and establishment of a data connection is required.

The UE is initially in an unregistered state and wishes to register with the network and establish a default packet data system bearer context. The UE has previously scanned for available Public Land Mobile Networks (PLMNs) and identified a preferred PLMN to attach to. The UE then sends, in step 200, a message including data of an attachment request, a packet data connectivity request and an indication that the UE supports registration separate from the establishment of a default EPS bearer to the MME of the selected PLMN in step 200. For example, the attachment request and PDN connectivity request may conform to 3GPP TS 24.301 V11.3.0, where the PDN connectivity request (an ESM message) is piggybacked into the attachment request (an EMM message). The indication that the UE supports registration separate from the establishment of a default EPS bearer may be provided in either the attachment request or the PDN connectivity request, for example as an additional information element. For example, it can be encoded in a way that it allows it to be ignored by an MME conforming only to 3GPP TS 24.301 V11.3.0 without causing an error in the MME. In some embodiments, the UE may also request activation of one or more dedicated EPS bearer contexts in addition to the default EPS bearer context. For example, a dedicated EPS bearer context might be required if there is call initiation at the time of the attach request.

The MME receives the attachment request and at step 202 determines whether the request includes an indication that the UE supports registration separate from the establishment of a default EPS bearer. If it is determined that the UE does support this, execution proceeds to step 204; otherwise execution proceeds to step 206 where the legacy procedure for attaching, for example as set out in 3GPP TS24.301 V11.3.0, is followed.

At step 204, the MME determines whether there are enough network resources to allocate the default EPS bearer context and any dedicated EPS bearer contexts that are also requested. For example, network congestion may mean that there is a temporary shortage of resources which prevents the default EPS bearer context and any dedicated EPS bearer contexts from being established immediately. If it is determined that there are enough resources, execution proceeds to step 206 where the legacy procedure for attaching, for example as set out in 3GPP TS24.301 V11.3.0, is followed. Otherwise, execution proceeds to step 208.

At step 208, the MME registers the UE with the network and transmits an attachment accept message including data giving an indication that packet data connectivity is delayed and a period in which the UE should not attempt to request packet data connectivity. For example, in one embodiment, when only activation of the default EPS bearer context is requested, the MME may transmit a message including data of an ATTACH ACCEPT with a piggybacked ACTIVATE DEFAULT EPS BEARER CONTEXT REQUEST message where the ACTIVATE DEFAULT EPS BEARER CONTEXT REQUEST message is altered to indicate that no default EPS bearer context has been established, implicitly signalling that it has been delayed. This does not cause problems with backward compatibility with 3GPP TS24.301 V11.3.0 because at this stage the MME knows that the UE supports registration without establishing the default EPS bearer context. In another embodiment, the MME may transmit a message including data of an ATTACH ACCEPT with a piggybacked PDN CONNECTIVITY REJECT. In a further embodiment, the MME may omit the ACTIVATE DEFAULT EPS BEARER CONTEXT REQUEST completely. This may require further changes in signalling to maintain compatibility with 3GPP TS24.301 because it is a mandatory requirement. The indication that no default EPS bearer context has been established can be made in any other suitable way, for example by including a specific code or information element indicating a delay in the establishment, or implicit, for example by informing the UE that no PDN connectivity has been established. In embodiments in which one or more dedicated EPS bearer contexts are also requested, the same messages can be transmitted as described above and will then be interpreted by the UE as meaning that the dedicated EPS bearer contexts have also not been established. In other embodiments further messages relating to the non-establishment of the dedicated EPS bearer contexts can be transmitted piggybacked with the attach accept, for example a BEARER RESOURCE ALLOCATION REJECT message as discussed in 3GPP TS24.301.

The UE receives the attachment accept message and at step 210 determines whether the contents include an indication that no packet data connectivity has been established. If the contents do include the indication, execution proceeds to step 212, whereas if the contents do not include the indication, execution proceeds to step 214 and legacy procedure for LTE as defined in 3GPP TS24.301 V11.3.0 are followed.

At step 212, the UE updates its state to registered without a packet data connection. For example using the states defined in 3GPP TS24.301 V11.3.0, the UE may have the states EMM REGISTERED while the ESM sublayer has the state BEARER CONTEXT INACTIVE to indicate that no EPS bearer exists.

Next, at step 216, the UE sends an attach complete message including data giving an indication that no packet data connectivity has been established to the MME. For example the attach complete message can be an ACTIVATE DEFAULT EPS BEARER CONTEXT ACCEPT message modified to indicate that the UE has acknowledged the establishment of the EPS bearer is delayed. In other embodiments a new message may be used because by this stage in the signal flow, both UE and MME know that the other supports separate registration and packet data connectivity establishment. In embodiments in which one or more dedicated EPS bearer contexts are also requested, the same messages can be transmitted by the UE as discussed above and will be then be interpreted by the MME as also acknowledging that requested dedicated EPS bearer contexts have not been established. In other embodiments further messages relating to the non-establishment of the dedicated EPS bearer contexts can be transmitted, for example an ACTIVATE DEDICATED EPS BEARER CONTEXT ACCEPT message as discussed in 3GPP TS24.301 modified to indicate that the UE has acknowledged that the establishment of the dedicated EPS bearer context is delayed.

At step 218, the UE determines whether the attach accept message indicates a temporary resource shortage and includes a period of time in which data connectivity should not be requested. If it does, a timer is started and up until the period of time has elapsed, any requests for packet data connectivity from the UE, for example triggered by other systems within the UE, are suppressed (step 220). In one embodiment the value of the timer is derived from the ESM back-off timer value T3396, which is defined in 3GPP TS 24.008, incorporated herein by reference, via a number of two second ticks after receipt of the attach accept. Conversely, if the attachment message does not specify a period of time in which data connectivity should not be requested, further packet data connectivity requests from the UE are not suppressed.

At step 222, following receipt of the attach complete message, the MME determines whether there are sufficient resources to allocate the default EPS bearer context. If there are not, a loop is executed to check again for sufficient resources. When it is determined that there are sufficient resources, the MME transmits a message with data indicating that the default EPS bearer has been established at step 224. For example, this can be an ACTIVATE DEFAULT EPS BEARER CONTEXT REQUEST message. This is received by the UE, which updates its state to have BEARER CONTEXT ACTIVE at step 226 and transmits message to the MME at step 228 with data indicating that the data connection has been established. For example it can transmit an ACTIVATE DEFAULT EPS BEARER CONTEXT ACCEPT message. The attachment procedure is now complete: the UE is registered with the MME and the default EPS bearer context is active.

In some embodiments, steps 218 and 220 are omitted and the message transmitted at step 208 by the MME does not indicate a period of time in which further packet data connectivity requests should be suppressed.

In this embodiment, the MME can register a user equipment with a network and delay the establishment of a packet data connection without causing an error condition. This gives more flexibility to the MME at times of network congestion. The UE knows that its attach request has been received and that the packet data connection will be established when resources are available. The number of messages exchanged can be reduced compared to a procedure in which the attach request is rejected because of insufficient resources and the UE repeatedly resubmits the attach request until it is accepted or a maximum number of retries is reached. A further advantage is that the UE can receive information that no data connection has been established and possibly choose to attach to another network with more resources at the present time.

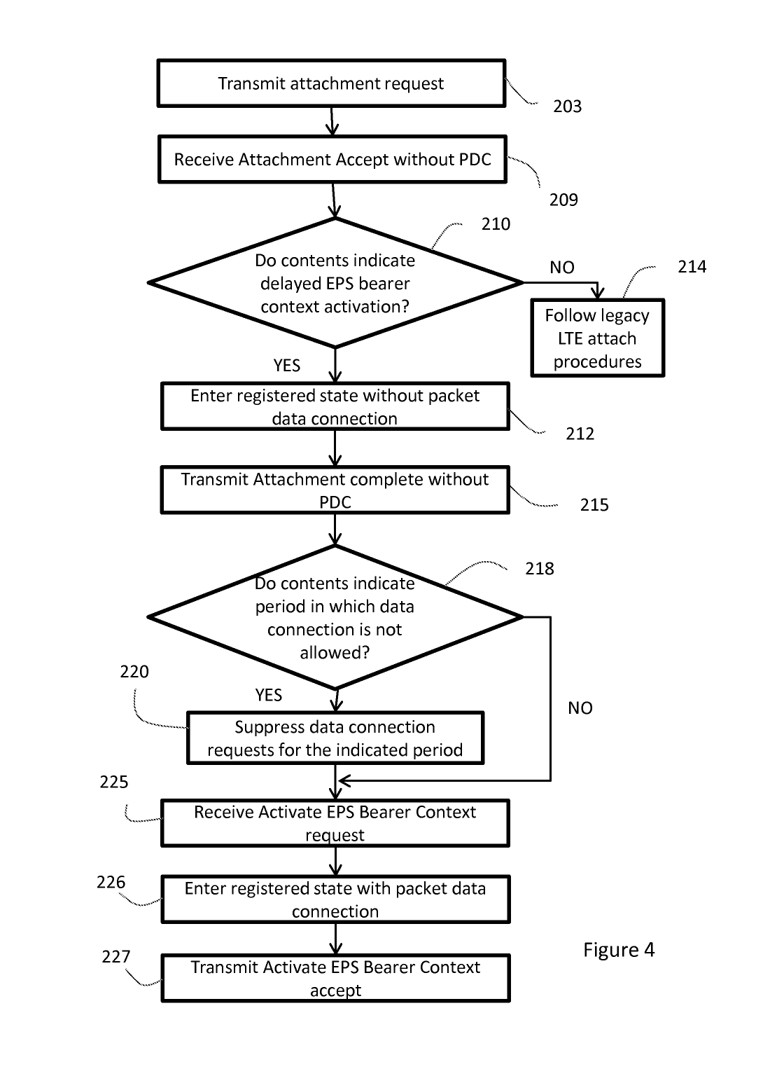

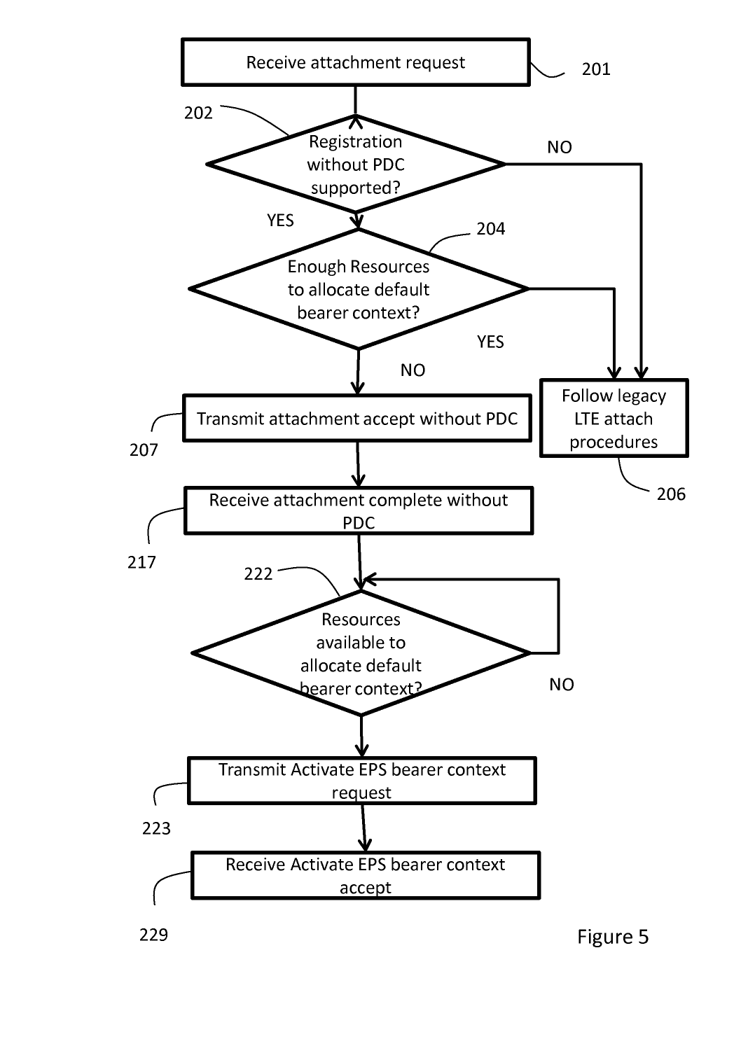

Further details of the processing carried out by each of the UE and the MME in the embodiment of FIG. 3 will now be described, with reference to FIGS. 4 and 5.

FIG. 4 shows a flow chart of the processing carried out by the UE. When the UE is an unregistered state and wishes to attach to a wireless network, the UE transmits an attachment request to the MME in step 203. In this embodiment the UE does not know whether the MME supports registration without establishing a default packet data connection. As discussed above in relation to FIG. 3, the attachment request is accompanied by a packet data connectivity request and an indication that the UE supports registration separate from the establishment of a default EPS bearer. These can be formed as discussed above for FIG. 3.

A response from the MME is received in step 209. This is an attachment accept message is used to signal to the UE whether the establishment of a packet data connection has been delayed. It can have the form as discussed above for FIG. 3.

Next, at step 210, the UE determines whether the contents of the received response include an indication that no packet data connectivity has been established or that the establishment of the packet data connection has been delayed. If the contents do include such indication, execution proceeds to step 212. Otherwise execution proceeds to step 214 and legacy procedure for LTE attachment as defined in 3GPP TS24.301 V11.3.0 are followed.

At step 212, the UE updates its state to registered without a packet data connection. For example using the states defined in 3GPP TS24.301 V11.3.0, the UE may have the states EMM REGISTERED while the ESM sublayer has the state BEARER CONTEXT INACTIVE to indicate that no EPS bearer exists.

To provide acknowledgement to the MME that the registration without a packet data connection has been received, the UE transmits an attachment complete message at step 215. This includes an indication that no packet data connectivity has been established by the MME and can have the form as discussed above for FIG. 3.

Next, at step 218, the UE determines whether the attachment complete message includes a period of time in which data connectivity should not be requested. If it does, a timer is started and up until the period of time has elapsed, any requests for packet data connectivity from the UE, for example triggered by other systems within the UE, are suppressed at step 220 so that no requests for data connectivity are sent Conversely, if the attachment message does not specify a period of time in which data connectivity should not be requested, further packet data connectivity requests from the UE are not suppressed.

A notification message from the MME is received at step 225. In this embodiment, this is an ACTIVATE DEFAULT EPS BEARER CONTEXT REQUEST message indicating that the default EPS bearer has been established. The UE then updates its state to have BEARER CONTEXT ACTIVE at step 226 and transmits an acknowledgement, which is an ACTIVATE DEFAULT EPS BEARER CONTEXT ACCEPT message in this embodiment, to the MME at step 227. The attachment procedure is now complete and the UE is registered with the MME and the default EPS bearer context is active.

In the embodiment of FIG. 4, a UE is able to request attachment with packet data connectivity. The MME is able to delay the establishment of packet data connectivity at times of network congestion.

In some embodiments, steps 218 and 220 are omitted and the received attachment accept message from the MME does not includes a period of time in which packet data connectivity requests are suppressed.

FIG. 5 depicts a flow chart of processing carried out by the MME in the embodiment of FIG. 3. The MME receives an attachment request from the UE at step 201. Execution then proceeds to step 202 where it is determined whether the request includes an indication that the UE supports registration separate from the establishment of a default EPS bearer. If it is determined that the UE does support this, execution proceeds to step 204, otherwise execution proceeds to step 206 where the legacy procedure for attaching, for example as set out in 3GPP TS24.301 V11.3.0, is followed.

At step 204, the MME determines whether there are enough network resources to allocate the default EPS bearer context. For example, network congestion may mean that there is a temporary shortage of resources which prevents the default EPS bearer context from being established immediately. If it is determined that there are enough resources, execution proceeds to step 206 where the legacy procedure for attaching, for example as set out in 3GPP TS24.301 V11.3.0, is followed. If it is determined that there are insufficient resources at this time, the MME registers the UE with the network and transmits, at step 207, an attachment accept message including an indication that packet data connectivity is delayed and a period in which the UE should not attempt to request packet data connectivity. This can have the form as described above for FIG. 3.

Next, at step 217, an attach complete message including an indication that no packet data connectivity has been established is received by the MME. The attach complete message can have the form as described above for FIG. 3.

At step 222, following receipt of the attach complete message, the MME determines whether there are now sufficient resources to allocate the default EPS bearer context. If not, a loop is executed to check again for sufficient resources. When it is determined that there are sufficient resources, the MME establishes a default bearer context and transmits a notification indicating that the default EPS bearer has been established at step 223. An acknowledgement of this message is received by the MME from the UE at step 228. The attachment procedure is now complete and the UE is registered with the MME and the default EPS bearer context is active.

In some embodiments, steps 218 and 220 are omitted and the MME does not indicate a period of time in which further packet data connectivity requests should be suppressed in step 208.

In the signal flows described above for FIGS. 3, 4 and 5, the UE submitted a request for a packet data connection with the attachment request. The MME can therefore assume that the UE anticipates use of the packet data connectivity immediately or relatively soon to request it at the same time as attachment, because otherwise the UE would have requested registration without a packet data connection. In further embodiments, the MME may consider the length of time before there will be sufficient resources to establish a packet data connection for the UE. Thus, if the MME determines that there will be a long delay before there are resources for a packet data connection (for example more than 15 seconds, more than 30 seconds, more than 1 minute, or some other period depending on user preference or network settings) it can choose to reject the attachment request to cause the UE to search for an alternative wireless network which can offer data connectivity sooner. In that case the reject message sent to the UE can indicate a resource shortage to so that the UE can attach to an alternative network if desired, rather than repeat attach requests to the congested network.

In other embodiments, the UE may use the indications of a temporary resource shortage and the period in which data connections are not allowed in the data of the attachment accept message to determine whether to continue the attachment with the commensurate delay to data connectivity, or to attempt to attach to another wireless network which may be able to provide data connectivity sooner. For example, if the period in which data connections are not allowed is greater than 30 seconds or greater than a minute the UE may stop or terminate the attachment procedure and initiate attachment to a different wireless network.

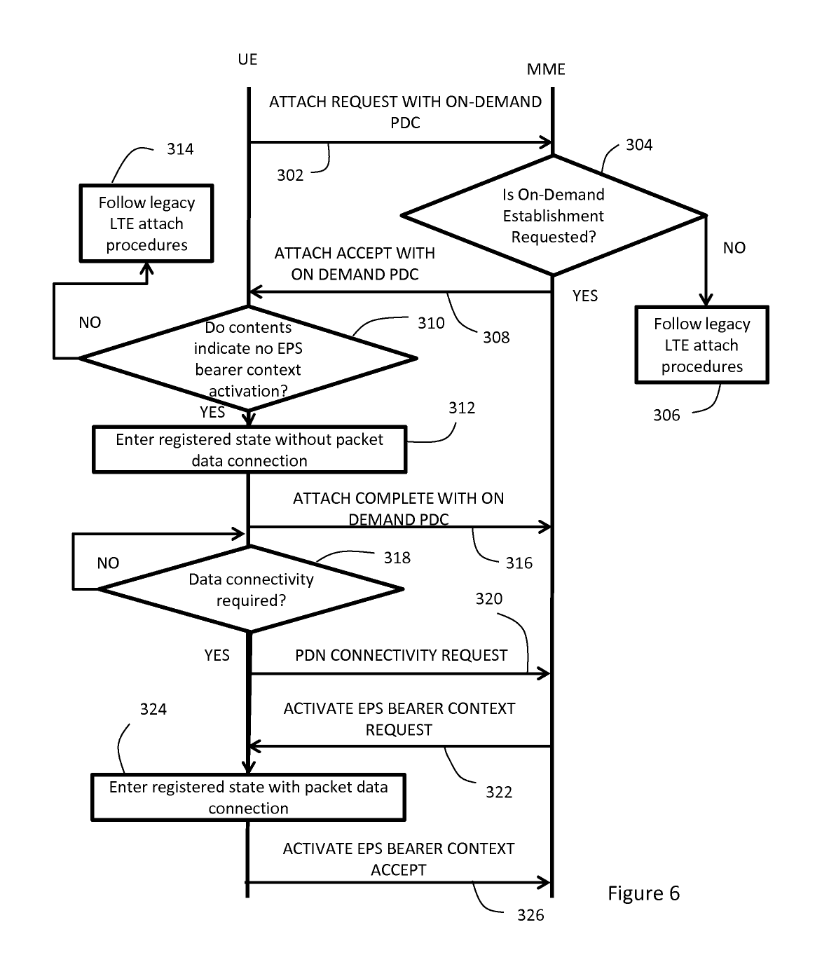

An embodiment will now be described in which a UE can request attachment to a wireless network when the UE does not require that a packet data connection is established at the time of attachment. As with the embodiment of FIGS. 3-5, the UE has no prior knowledge of whether the MME supports registration without immediate establishment of a default packet data connection. This embodiment allows an MME to request attachment without a packet data connection while maintaining compatibility with MMEs which comply with 3GPP TS24.301 V11.3.0 where a default EPS bearer context is always set up when a UE attaches to the network. FIG. 6 depicts the signal flows of such an embodiment. Although this embodiment will be described with reference to 3GPP TS24.301 V11.3.0, the embodiment can be applied to any system where a default data connection is created when a UE attaches to a network.

The UE is initially unregistered and has scanned for and selected a wireless network to attach to. The UE also knows that data connectivity will not be required for some time, for example not for at least an hour, a day, a week or a month, depending on the data transfer window used by the device in question. There is therefore no requirement for a default EPS bearer context to be established when the UE connects to the wireless network. However, the UE does not know whether the MME supports registration without also establishing a default data connection.

At step 302, the UE transmits an attach request to the MME with an indication that the UE supports registration without establishing a packet data connection and also that a packet data connection is not required, so that a packet data connection will be requested later on demand. For example, the attachment request may conform to 3GPP TS 24.301 V11.3.0. The indication that the UE supports registration separate from the establishment of a default EPS bearer may be provided in the attachment request as an additional information element. For example, it can be encoded in a way that it allows it to be ignored by an MME conforming only to 3GPP TS 24.301 V11.3.0 without causing an error in the MME. In another embodiment, the PDN Connectivity Request defined in 3GPP TS24.301 V11.3.0 may be omitted. This gives an implicit indication both that the UE supports registration without establishing a packet data connection and also that a packet data connection is required. However, it will result in an error condition when received by an MME which does not support registration without establishing a packet data connection. As a result, the UE of this embodiment must detect and recover from the error by using a legacy attachment procedure in which registration is carried out together with creation of a default packet data connection.

The attach request is received by the MME and at step 304 the MME determines whether the attachment request contains an indication that the UE has requested that a packet data connection is not required, so that a packet data connection will be established on demand. If it is determined that a packet data connection is required, processing continues with legacy LTE attach procedures in step 306, otherwise execution proceeds to step 308. In some embodiments, if it is determined that a packet data connection is required, processing may continue according to the embodiment of FIG. 3-5 (from step 202) rather than a legacy LTE attach procedure.

At step 308, the MME registers the UE with the network and transmits an attach accept message including an indication that a packet data connection has not been established and will be established on demand. For example, in one embodiment the MME may transmit an ATTACH ACCEPT message combined with an ACTIVATE DEFAULT EPS BEARER CONTEXT message where the ACTIVATE DEFAULT EPS BEARER CONTEXT message is altered to indicate no establishment of the default EPS bearer connection. In another embodiment the MME may respond with a PDN CONNECTIVITY REJECT message piggybacked with the ATTACH ACCEPT message, explicitly indicating that no packet data connectivity has been established. This does not cause problems with backward compatibility with 3GPP TS24.301 V11.3.0 because at this stage the MME knows that the UE supports registration without establishing the default EPS bearer context.

The UE receives the attach accept message and at step 310 determines whether the contents indicate that a packet data connection has not been established. This allows the UE to determine whether the MME supports registration without establishing default data connectivity. A further advantage is that this check allows the network to enforce default data connectivity and reject the request for attachment without a default data connection without an error state. If it is determined that the contents of the attach accept indicate that no data connection has been established, execution proceeds to step 312. Otherwise execution proceeds to step 314 and legacy attach procedures are followed, for example those defined in 3GPP TS24.301 V11.3.0.

At step 312, the UE enters a registered state without a packet data connection. For example, using the states defined in 3GPP TS24.301 V11.3.0, the UE may have the states EMM REGISTERED while the ESM sub-layer has the state BEARER CONTEXT INACTIVE to indicate that no EPS bearer exists.

The UE then transmits an Attach complete message to the MME at step 316. The Attach complete message includes an indication that no packet data connection has been set up. For example, the attach complete message can be an ACTIVATE DEFAULT EPS BEARER CONTEXT ACCEPT message modified to indicate that the UE has acknowledged the establishment of the EPS bearer is delayed. In other embodiments a new message may be used because, by this stage in the signal flow, both UE and MME know that the other supports separate registration and packet data connectivity establishment. The MME receives the Attach Complete message and awaits further communication from the UE to establish a packet data connection.

The UE the monitors for whether data connectivity is required in step 318, and this monitoring continues until data connectivity is required, whereupon execution proceeds to step 320. For example, data connectivity may be requested by another service or system running on the UE or may be triggered by the expiration of a timer.

At step 320, the UE transmits a PDN CONNECTIVITY REQUEST (or BEARER RESOURCE ALLOCATION REQUEST, if dedicated EPS bearer context is requested) to the MME. The PDN CONNECTIVITY REQUEST/BEARER RESOURCE ALLOCATION REQUEST can conform to the requirements set out in 3GPP TS24.301 V11.3.0 or may have a different format. This is received by the MME which establishes a default or dedicated EPS bearer context as requested and sends an activation message to the UE at step 322. For example, this can be an ACTIVATE DEFAULT EPS BEARER CONTEXT message as defined in 3GPP TS24.301 V11.3.0 In some embodiments the MME can check the availability of resources for the packet data connection before activating it, for example by following the process of the embodiment of FIGS. 3, 4 and 5.

The UE receives the ACTIVATE DEFAULT EPS BEARER CONTEXT message and updates its state to registered with a packet data connection at step 324. For example, the state of the EPS sub-layer may change to BEARER CONTEXT ACTIVE. An acceptance is then sent to the MME in step 326. For example an ACTIVATE DEFAULT EPS BEARER CONTEXT ACCEPT message may be sent. The UE is now registered with the wireless network and a default data connection has been established.

This embodiment allows a UE to request registration with the network without establishing a packet data connection. This can reduce resource usage in the network because packet data connections can be established when required by the UE. It is particularly beneficial for UE using MTM communication, in which communication may occur relatively infrequently with long time intervals between transmissions.

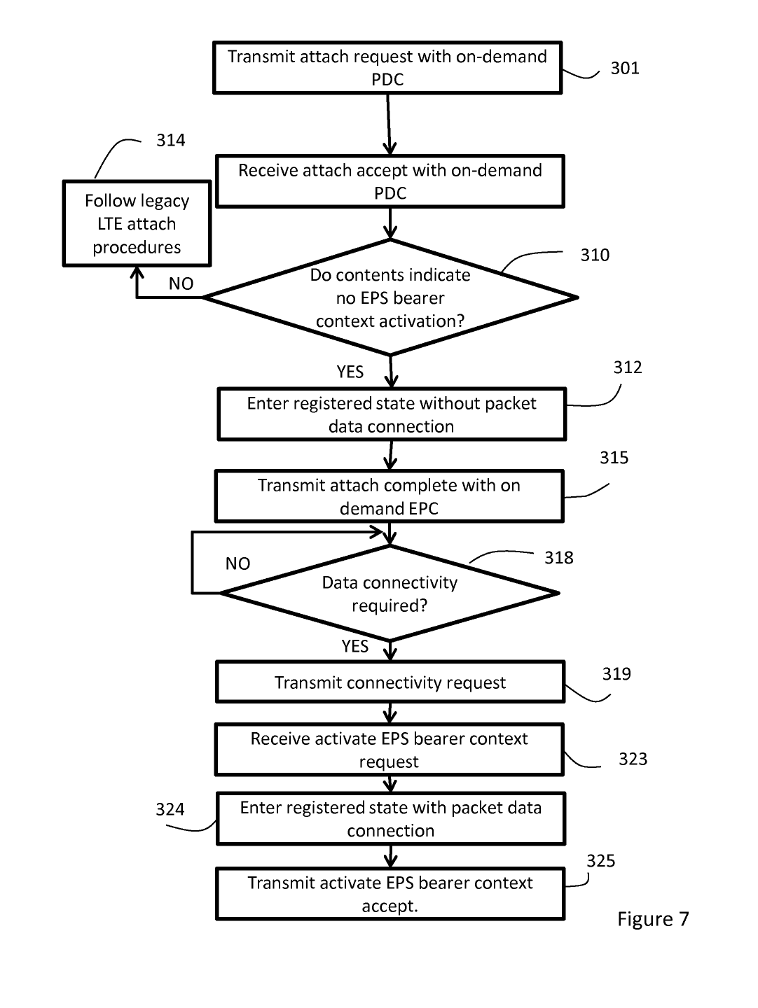

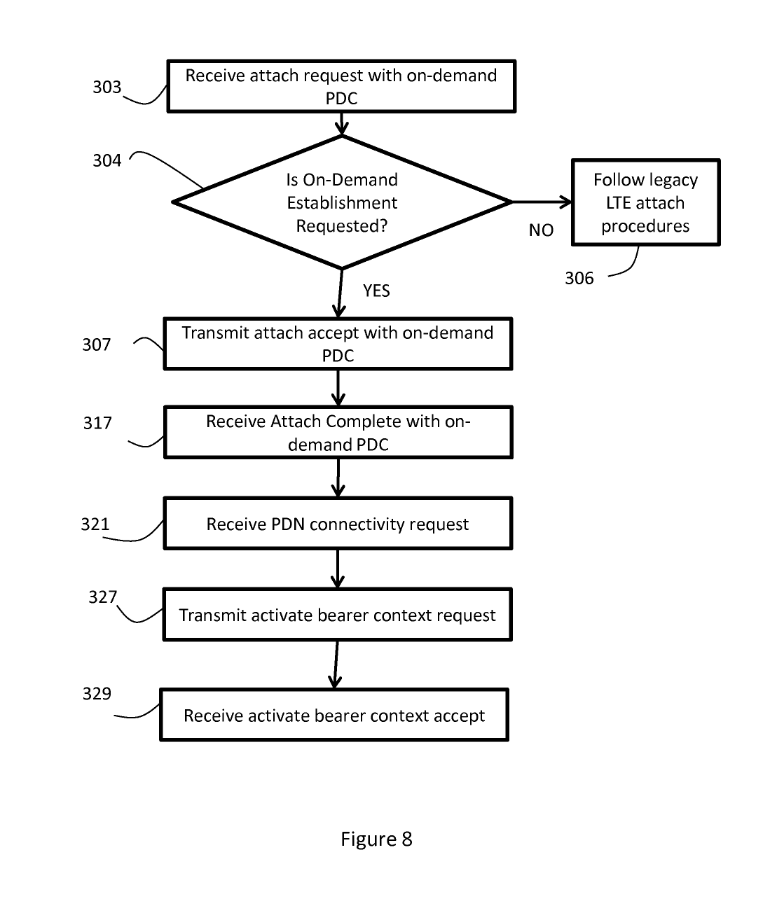

Further details of the processing carried out by each of the UE and the MME in the embodiment of FIG. 6 will now be described, with reference to FIGS. 7 and 8.

FIG. 7 depicts the processing by the UE in the embodiment of FIG. 6. The UE is initially unregistered and has scanned for and selected a wireless network to attach to. At step 301, the UE transmits an attach request to the MME with an indication that the UE supports registration without establishing a packet data connection and also that a packet data connection is not required, so that a packet data connection will be requested later on demand. The way in which this attach request can be formed is discussed above.

The UE then receives, at step 309, an attach accept message from the MME. The form that this attach accept message can take is discussed above. Next, at step 310, the UE determines whether the contents of the attach accept message indicate that a packet data connection has not been established. If it is determined that the contents of the attach accept indicate that no data connection has been established, execution proceeds to step 312. Otherwise execution proceeds to step 314 and legacy attach procedures are followed, for example those defined in 3GPP TS24.301 V11.3.0.

At step 312, the UE enters a registered state without a packet data connection. For example, using the states defined in 3GPP TS24.301 V11.3.0, the UE may have the states EMM REGISTERED while the ESM sub-layer has the state BEARER CONTEXT INACTIVE to indicate that no EPS bearer exists as discussed above.

The UE then transmits (at step 315) an Attach complete message to the MME. The Attach complete message includes an indication that no packet data connection has been set up and can have a form as described above in relation to FIG. 6. The UE then enters a loop to monitor for whether data connectivity is required in step 318. This continues to loop until data connectivity is required, when execution proceeds to step 319.

At step 319, the UE transmits a connectivity request, for example a PDN CONNECTIVITY REQUEST or BEARER RESOURCE ALLOCATION REQUEST to the MME. The PDN CONNECTIVITY REQUEST or BEARER RESOURCE ALLOCATION REQUEST can conform to the requirements set out in 3GPP TS24.301 V11.3.0 or may have a different format. Next, the UE receives a notification that a packet data connection has been established at step 323. For example an ACTIVATE DEFAULT EPS BEARER CONTEXT REQUEST message may be received. The UE then updates its state to registered with a packet data connection at step 324. For example, the state of the EPS sub-layer may change to BEARER CONTEXT ACTIVE. An acceptance is then transmitted to the MME in step 325. For example an ACTIVATE DEFAULT EPS BEARER CONTEXT ACCEPT message may be sent. The UE is now registered with the wireless network and a default data connection has been established.

FIG. 8 depicts the processing by the MME in FIG. 6. At step 303, an attach request from a UE is received by the MME. Processing then proceed to step 304, where it is determined whether the attach request contains an indication that the UE has requested that a packet data connection is not required, so that a packet data connection will be established on demand. If it is determined that a packet data connection is required, processing continues with legacy LTE attach procedures in step 306, otherwise execution proceeds to step 307. In some embodiments, if it is determined that a packet data connection is required, processing may continue according to the embodiment of FIG. 5 (from step 202) rather than a legacy LTE attach procedure.

The MME registers the UE with the network and transmits an attach accept message including an indication that a packet data connection has not been established and will be established on demand at step 307. The form of the attach accept message can be as discussed above for FIG. 6.

An Attach complete message is received from the UE at step 317. The Attach complete message includes an indication that no packet data connection has been set up and can have a form as discussed above for FIG. 6. The MME then awaits further communication from the UE to establish a packet data connection.

At step 321, the MME receives a connectivity request message from the UE, which has the form discussed above for FIG. 6. The MME establishes a default EPS bearer context and transmits an activation message to the UE at step 327. This can have the form discussed above for FIG. 6. In some embodiments the MME can check the availability of resources for the packet data connection before activating it, for example by following the process of the embodiment of FIG. 5 from step 202.

Finally an acknowledgement of the activation of the default bearer context is received at step 329. The UE is now registered with the wireless network and a default data connection has been established.

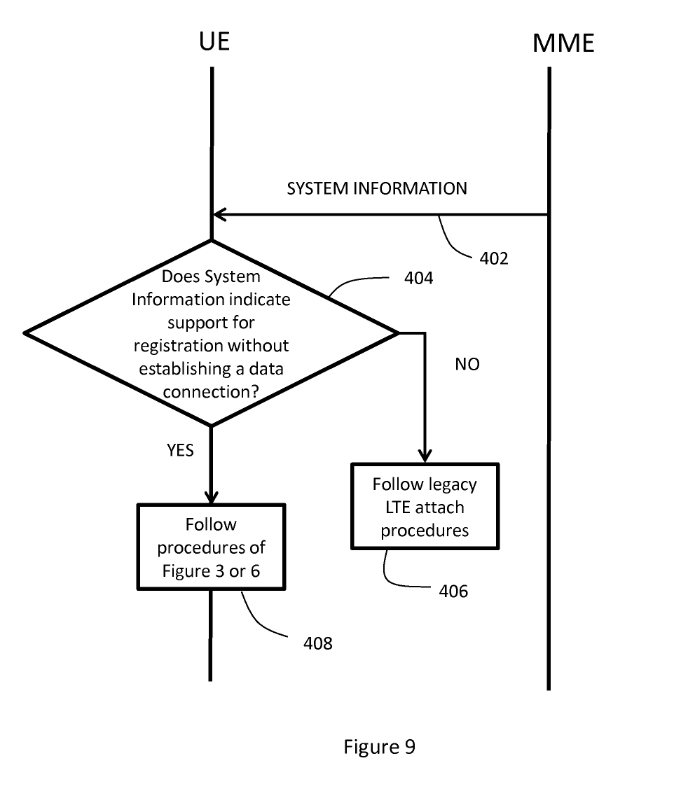

Embodiments in which the UE has prior knowledge that the MME supports registration without establishing a packet data connection will now be described. This allows more freedom in the format in which messages are exchanged between the UE and the MME because from the beginning of the attach procedure there is knowledge that both sides support the feature and the need to maintain compatibility with legacy devices is smaller. This can allow use of simpler messages making the process more efficient. Nevertheless in some of these embodiments, the messages are still designed to be as compatible with legacy procedures as possible to minimise problems with knock-on effects to other parts of the wireless network. In these embodiments, the processes are generally the same as described above, but begin with the broadcast of system information which includes an indication that the network supports registration without establishing a packet data connection. The UE can therefore decide whether to use a legacy procedure in which a packet data connection is established at the same time as registering the device on the network, for example as defined in 3GPP TS24.301 V11.3.0, or use a procedure in which allows registration without establishing a packet data connection. FIG. 9 depicts the additional signal flows used in these embodiments.

Referring to FIG. 9, the signal flows between a UE and an MME are shown. These signal flows occur before the transmission of an attach request message in the embodiments of FIGS. 3 to 8. More specifically, they occur before the transmission of the attach request 200 in FIG. 3 and before the transmission of the attach request 302 in FIG. 6.

The MME periodically broadcasts system information at step 402. The system information is broadcast to, and received by, all compatible UE within range. The system information includes an indication the network supports registration without establishing a packet data connection. For example, the indication may be a specific bit or information element within the overall system information. In one embodiment the indication may be provided in system information that must be received before the UE accesses the network, for example in the message SystemInformationBlockType2 of the LTE Radio Resource Control (RRC).

The UE determines whether the system information indicates support for registration without establishing a data connection at step 404. If no support is indicated, the UE follows legacy attach procedures at step 406, for example those defined in 3GPP TS24.301 V11.3.0. Otherwise, the UE can continue to follow the procedures described above with reference to FIGS. 3 to 8. The format of the messages exchanged can be as described above or can be modified to improve efficiency. For example, because the UE knows from the start that the MME supports registration without a data connection, the PDN CONNECTIVITY REQUEST can be omitted at step 302 without risk of causing an error condition at the MME.

In other embodiments using the system information broadcast of FIG. 9 the messages may be further optimised. For example, piggy-backed ESM messages may be omitted completely until a packet data connection is required. It is also possible to define a completely new set of message formats, which can be as efficient as possible because backwards compatibility is not required.

Embodiments using the system information broadcast of FIG. 9 require the broadcast of additional system information. This is a scarce resource in a wireless network and the benefits of more efficient messages should be balanced against the impact of including additional data in the system information.

The above embodiments are to be understood as illustrative examples of the invention. Further embodiments of the invention are envisaged. In another embodiment, if a UE requires a default data connection to be activated on registration with the network, it may transmit an attach request message as defined in 3GPP TS24.301. The MME, on receiving such a message, does not know if the UE supports registration without a data connection. If the MME wishes to delay establishing a data connection because of insufficient resources, it could signal this to the UE by modifying a connection reject message in way that maintains backwards compatibility with 3GPP TS24.301, for example by including a new information element. This could then avoid repeated attach requests from the UE while the network is congested.

Although the above described embodiments have been described in the context of a UE and MME following the technical specifications for 3GPP LTE and configured to operate within a LTE system, it will be appreciated that the further embodiments can be applied to other systems. For example, further embodiments can also be applied to devices following the technical specifications 3GPP Long Term Evolution-Advanced (LTE-A) and configured to work within an LTE-A system.

The processor of a UE can be further arranged to include in the first data an indication that the user equipment does not require a packet data connection to be established immediately, dependent upon the result of a determination of whether a packet data connection is required. This allows more efficient use of network resources.

The processor of a UE can be further arranged to terminate the registration with the wireless network and request registration with another wireless network if it is determined from the second data that a packet data connection has not been established because of insufficient network resources. This can avoid repeated attach requests to a congested network that has insufficient resources for a packet data connection.

The processor of a UE can be further arranged to, responsive to the second data including an indication that the establishment of a packet data connection is delayed: extract a value from the second data indicating a period of time during which the user equipment should not attempt to establish a packet data connection; and not attempt to establish a packet data connection until after a period of time equal to or greater than the extracted value. This can avoid further network congestion cause by repeated attach requests from the UE.

The processor of a UE can be further arranged to, responsive to receipt of a message with third data indicating that a packet data connection has been established while the user equipment is in the registered state without a packet data connection, configure the user equipment to a registered state with a packet data connection. This allows the UE to change state in response to a message from MME, rather than the UE requesting the data connectivity.

The processor of a UE can be further arranged to transmit the indication that the user equipment supports registering without establishing a packet data connection in the first data in dependence on received broadcast system information. This can avoid errors in equipment that does not support the feature.

The processor of an MME can further arranged to, responsive to the first data including an indication that a packet data connection is not required: not establish a packet data connection for the user equipment; and include in the second data an indication that a packet data connection has not been established because the first data indicated that immediate establishment of a packet data connection was not required. This allows the UE to know not to expect further communication from the MME regarding the establishment of the packet data connection until one is requested by the UE.

The processor of an MME can be further arranged to determine the availability of resources to establish a packet data connection for the user equipment; wherein a packet data connection is established or not established in dependence on the first data and on the availability of resources. This allows an MME to delay creation of the packet data connection when the first data indicates that the UE supports it and there are insufficient network resources.

When a packet data connection is not established because of insufficient resources, the processor of the MME can be further arranged to include in the second data an indication that the packet data connection has not been established because of insufficient resources. This allows the UE to make a decision to attach to a different wireless network.

The processor of an MME can be further configured to include in the second data a value defining a period of time during which the user equipment should not attempt to establish a packet data connection. This avoids repeated attach requests from the UE which could further increase network congestion.

The processor of an MME can be further arranged to broadcast system information including an indication that the registration of user equipment without establishing a packet data connection for the user equipment is supported. This allows the UE to use a more efficient attach procedure when a packet data connection is not required at the same time as registration.

It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

1. An apparatus for configuring a user equipment for transmission of data over a wireless network, the apparatus comprising a processor arranged to, when in an unregistered state:
transmit a message comprising first data indicating a request for attachment to the network, wherein the first data includes an indication that the user equipment supports registration without establishing a packet data connection; and
responsive to receipt of a message comprising second data indicating an acceptance of the request for attachment to the network, selectively configure the user equipment to one of a registered state without a packet data connection and a registered state with a packet data connection in dependence on the second data.

2. An apparatus according to claim 1, wherein the processor is further arranged to include in the first data an indication that the user equipment does not require a packet data connection to be established immediately, dependent upon the result of a determination of whether a packet data connection is required.

3. An apparatus according to claim 1, wherein the processor is further arranged to terminate the registration with the wireless network and request registration with another wireless network if it is determined from the second data that a packet data connection has not been established because of insufficient network resources.

4. An apparatus according to claim 1, wherein the processor is further arranged to, responsive to the second data including an indication that the establishment of a packet data connection is delayed:
extract a value from the second data indicating a period of time during which the user equipment should not attempt to establish a packet data connection; and
not attempt to establish a packet data connection until after a period of time equal to or greater than the extracted value.

5. An apparatus according to claim 1, wherein the processor is further arranged to:
responsive to receipt of a message with third data indicating that a packet data connection has been established while the user equipment is in the registered state without a packet data connection, configure the user equipment to a registered state with a packet data connection.

6. An apparatus according to claim 1, wherein the processor is further arranged to:
transmit the indication that the user equipment supports registering without establishing a packet data connection in the first data in dependence on received broadcast system information.

7. An apparatus according to claim 1 configured for use in a Long Term Evolution system.

8. An apparatus according to claim 1 configured for use in a Long Term Evolution-Advanced system.

9-10. (canceled)

11. An apparatus for registering and for establishing packet data connections for user equipment on a wireless network, the apparatus comprising a processor arranged to, responsive to receipt of a message comprising first data indicating a request for attachment to the wireless network from the user equipment:
register the user equipment on the wireless network;
either establish or not establish a packet data connection for the user equipment in dependence on the first data; and
transmit a message comprising second data indicating an acceptance of the request for attachment to the network and whether a packet data connection has been established for the user equipment.

12. An apparatus according to claim 11, wherein the processor is further arranged to, responsive to the first data including an indication that a packet data connection is not required:
not establish a packet data connection for the user equipment; and
include in the second data an indication that a packet data connection has not been established because the first data indicated that immediate establishment of a packet data connection was not required.

13. An apparatus according to claim 11, wherein the processor is further arranged to,
determine the availability of resources to establish a packet data connection for the user equipment;
wherein a packet data connection is established or not established in dependence on the first data and on the availability of resources.

14. An apparatus according to claim 13, wherein when a packet data connection is not established because of insufficient resources, the processor is further arranged to include in the second data an indication that the packet data connection has not been established because of insufficient resources.

15. An apparatus according to claim 13, wherein the processor is further configured to include in the second data a value defining a period of time during which the user equipment should not attempt to establish a packet data connection.

16. An apparatus according to claim 11, wherein the processor is further arranged to broadcast system information including an indication that the registration of user equipment without establishing a packet data connection for the user equipment is supported.

17. An apparatus according to claim 11 configured for use in a Long Term Evolution system.

18. An apparatus according to claim 11 configured for use in a Long Term Evolution-Advanced system.

19. (canceled)

20. A method of configuring a user equipment for transmission of data over a wireless network, the method comprising:
transmitting, by the user equipment, a message comprising first data indicating a request for attachment to the network, wherein the request includes an indication that the user equipment supports registration without establishing a packet data connection; and
responsive to receipt, by the user equipment, of a message comprising second data indicating an acceptance of the request for attachment to the network, selectively configuring the user equipment to one of a registered state without a packet data connection and a registered state with a packet data connection in dependence on the second data.

21. A method according to claim 20, wherein the first data further includes an indication that the user equipment does not require a packet data connection to be established immediately dependent upon a determination of whether a packet data connection is required.

22. A method according to claim 21, further comprising terminating the registration with the wireless network and requesting registration with another wireless network if it is determined from the second data that a packet data connection has not been established because of insufficient network resources.

23. A method according to claim 20, wherein the method further comprises, responsive to the second data including an indication that the establishment of a packet data connection is delayed:
extracting, by the user equipment, a value from the second data indicating a period of time during which the apparatus should not attempt to establish a packet data connection; and
not attempting to establish a packet data connection by the user equipment until after a period of time equal to or greater than the extracted value.

24-34. (canceled)
